(19) United States
(12) Patent Application Publication
(10) Pub. No.: US 2016/0111123 A1
(43) Pub. Date: Apr. 21, 2016

(54) OPTICAL INFORMATION RECORDING/REPRODUCTION DEVICE AND ADJUSTMENT METHOD

(71) Applicant: HITACHI CONSUMER ELECTRONICS CO., LTD., Yokohama-shi, Kanagawa (JP)

(72) Inventors: Mayumi NAGAYOSHI, Tokyo (JP); Taku HOSHIZAWA, Tokyo (JP); Kazuyoshi YAMAZAKI, Tokyo (JP); Makoto HOSAKA, Tokyo (JP)

(21) Appl. No.: 14/892,019

(22) PCT Filed: Jun. 14, 2013
(86) PCT No.: PCT/JP2013/066417

§ 371 Date: Nov. 18, 2015

(51) Int. Cl. G11B 7/1353; G11B 7/1392; G11B 7/1374; G11B 7/1362; G11B 7/1359

(52) U.S. Cl. CPC G11B 7/1353; G11B 7/1362; G11B 7/1359; G11B 7/1374; G11B 7/13927

(57) ABSTRACT

The optical information recording/reproduction device for recording information by irradiating an optical information recording medium with signal light and reference light to form a hologram, and reproducing the information by irradiating the hologram with the reference light, wherein the optical information recording/reproduction device is provided with a branching element for branching laser light from a laser light source into signal light and reference light, a spatial light modulation unit for adding two-dimensional information to the signal light, an objective lens for irradiating an optical information recording medium with the signal light, a photodetector for detecting diffracted light from the optical information recording medium when irradiated with the reference light, and an optical axis adjustment unit disposed between the laser light source and the branching element, the optical axis adjustment unit adjusting the optical axis of the laser light.

### TECHNICAL FIELD

The present invention relates to a device and a method that record information in an optical information recording medium, using an interference pattern between signal light and reference light as page data, and/or reproduce information from the optical information recording medium.

### BACKGROUND ART

Presently, commercialization of consumer optical disks having recording density of about 50 GB has become possible by Blu-ray Disc™ standard using a blue-violet semiconductor laser. In the future, an increase in high capacity up to the same level as the capacity of a hard disk drive (HDD) of 100 GB to 1 TB is desired for the optical disks.

However, to realize such ultra-high density in the optical disks, a high-density technology with a new system is required, which is different from high-density technologies of a decrease in a wavelength and realization of high NA of an objective lens.

Hologram recording technologies of recording digital information, using holography, have received attention amidst the studies related to next-gen storage technologies.

The hologram recording technologies are technologies of overlapping signal light, which includes information of page data two-dimensionally modulated by a spatial light modulator, with reference light inside a recording medium, and causing refractive index modulation in the recording medium with an interference fringe pattern caused at the time of overlapping of the light, thereby to record the information in the recording medium.

At the time of reproduction of the information, when the recording medium is irradiated with the reference light used at the time of recording, a hologram recorded in the recording medium acts like a diffraction grating to cause diffracted light. This diffracted light is reproduced with the recorded signal light, including phase information, as the same light.

The reproduced signal light is two-dimensionally detected at a high speed, using a photodetector such as a CMOS or a CCD. As described above, the hologram recording technologies can record two-dimensional information in an optical recording medium with one hologram at once, and can reproduce the information. Further, the hologram recording technologies can overwrite a certain place in the recording medium with a plurality of page data. Therefore, high-capacity and high-speed information recording and reproduction can be achieved.

Patent Literature 1 describes that, “while a signal light is supplied in a state of according with an optical axis of an optical system at the time of recording a hologram, regardless of a form (a board thickness, an angle, a refractive index, or the like) of an optical information recording medium. However, reproduced light is taken out in a state of being deviated from the optical axis of the optical system at the time of reproduction, according to the form of the optical information recording medium. Therefore, by providing an optical axis deviation correction unit and moving a light-receiving system according to a deviation amount of the optical axis, an appropriate detection state can be maintained”.

### CITATION LIST

### PATENT LITERATURE 1: JP-A-2005-10599

### SUMMARY OF INVENTION

### Technical Problem

However, in an optical information recording/reproduction device, occurrence of position deviation and angle deviation is expected not only in an optical information recording medium but also in many arranged optical components due to thermal expansion by thermal change, vibration, and the like, at the time of recording and reproduction. When the position deviation and the angle deviation of a component are caused at the time of recording and reproduction, even if the optical component of the reference light is arranged to overlap with the signal light with a minimum light flux diameter, the light flux diameter of the reference light is changed due to deviation of the component, and for example, phenomena that excess exposure not contributing to the recording of the optical information recording medium is increased, and the reference light and the signal light do not interfere and appropriate recording cannot be performed, are expected. These phenomena may be a cause to prevent high density recording. Further, deviation of the optical component causes an aberration, and becomes a cause of deterioration of an SNR of a reproduced image.

Therefore, an objective of the present invention is to provide an optical information recording/reproduction device and an adjustment method that enable recording and reproduction of a high-quality hologram.

### Solution to Problem

The above problems are solved by the invention described in claims.

### Advantageous Effects of Invention

According to the present invention, an optical information recording/reproduction device and an adjustment method that enable recording and reproduction of a high-quality hologram can be provided.

### BRIEF DESCRIPTION OF DRAWINGS

FIG. 1 is a diagram illustrating a first embodiment of an optical pickup of the present invention.

FIG. 2 is a diagram illustrating a second embodiment of an optical pickup of the present invention.

FIG. 3 is a diagram illustrating an embodiment of angle deviation detection in an optical pickup of the present invention.

FIG. 4 is a diagram illustrating sensitivity of angle deviation of reference light with respect to an aberration in an optical pickup of the present invention.

FIG. 5 is a diagram illustrating sensitivity of position deviation of reference light with respect to an aberration in an optical pickup of the present invention.

FIG. 6(a) is a diagram illustrating the first embodiment for performing optical axis adjustment of the optical pickup of the present invention.

FIG. 6(b) is a diagram illustrating the first embodiment for performing optical axis adjustment of the optical pickup of the present invention.

FIG. 6(c) is a diagram illustrating the first embodiment for performing optical axis adjustment of the optical pickup of the present invention.

FIG. 7 is a diagram illustrating the second embodiment for performing optical axis adjustment of the optical pickup of the present invention.

FIG. 8 is a diagram illustrating a third embodiment for performing optical axis adjustment of the optical pickup of the present invention.

FIG. 9 is a diagram illustrating a fourth embodiment for performing optical axis adjustment of the optical pickup of the present invention.

FIG. 10 is a block diagram illustrating a recording/reproduction device of an optical information recording medium that records/reproduces digital information, using holography.

FIG. 11 is a diagram illustrating an operation flow of recording and reproduction in an optical information recording/reproduction device.

FIG. 12(a) is an adjustment flow of pre-shipment adjustment.

FIG. 12(b) is an adjustment flow during recording and reproduction.

FIG. 13(a) is a relationship (sectional view) between signal light and reference light in an optical information recording medium.

FIG. 13(b) is a relationship (bird's-eye view) between signal light and reference light in an optical information recording medium.

### DESCRIPTION OF EMBODIMENTS

Hereinafter, embodiments of the present invention will be described using appended drawings.

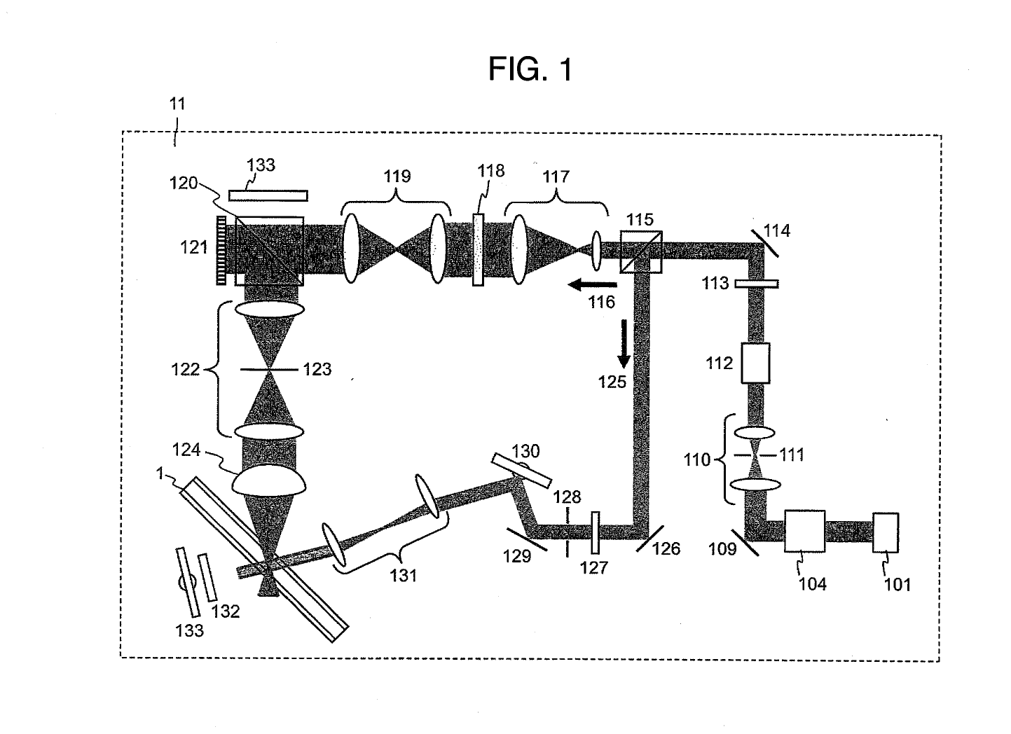

FIG. 1 illustrates an example of an optical system configuration of an optical pickup 11 in an optical information recording/reproduction device 10 of the present invention.

First, a recording process of a hologram will be described. A light beam emitted from a light source 101, such as a laser, is transmitted through a beam shaping element 104 to be shaped into a perfect circle shape. The light transmitted through a shutter 111 arranged in a focal distance of a relay lens 110, through a mirror 109, is prevented from becoming return light to the light source 101, by an optical isolator 112. Then, the light is incident on a polarization beam splitter (PBS) prism 115, after a polarization direction is controlled such that light quantity ratios of p polarized light and s polarized light become desired ratios by an optical element 113 configured from a ½ wavelength plate and the like.

The light beam transmitted through the PBS prism 115 works as signal light 116, and is transmitted through a phase mask 118, a relay lens 119, and a PBS prism 120, and is incident on a spatial light modulator 121, after a beam diameter is enlarged by a beam expander 117.

The signal light to which information is added by the spatial light modulator 121 is reflected at the PBS prism 120, and is propagated in a relay lens 122 and a polytopic filter 123. After that, the signal light is concentrated on an optical information recording medium 1 by an objective lens 124.

Meanwhile, the light beam reflected at the PBS prism 115 works as reference light 125, and is incident on a galvanometer mirror 130, after passing through a wedge prism 127 that is an angle adjustment element in a pitch direction, and an aperture 128 for controlling a light flux diameter of the reference light to prevent excess exposure of the optical information recording medium 1. The galvanometer mirror 130 can adjust an angle by an actuator, and thus can set the incident angle of the reference light incident on the optical information recording medium 1 after passing through a scanner lens 131 to a desired angle. To set the incident angle of the reference light, an element that converts a wavefront of the reference light may be used in place of the galvanometer mirror.

By causing the signal light and the reference light to be incident to be overlapped with each other in the optical information recording medium 1, an interference fringe pattern is formed in the recording medium, and the pattern is written in the optical information recording medium, so that the information is recorded. Further, the incident angle of the reference light to be incident on the optical information recording medium 1 can be changed by the galvanometer mirror 130. Therefore, recording by angle multiplexing can be performed.

Next, a reproduction process of a hologram will be described. A light beam obtained by causing the reference light 125 to be incident on the optical information recording medium 1, and to be transmitted through the optical information recording medium 1 passes through an optical element 132 configured from a ¼ wavelength plate, is reflected at a galvanometer mirror 130 that can adjust an angle by an actuator, and then passes through the optical element 132 again, so that a polarization state of the reference light is converted, and reproduction reference light is generated.

Reproduced light reproduced by the reproduction reference light is propagated in the objective lens 124, the relay lens 122, and the polytopic filter 123. Following that, the reproduced light is transmitted through the PBS prism 120 and is incident on a photodetector 133, so that the recorded signal can be reproduced. As the photodetector 133, an imaging element such as a CMOS image sensor or a CCD image sensor can be used, for example. However, any element can be used as long as the element can reproduce the page data.

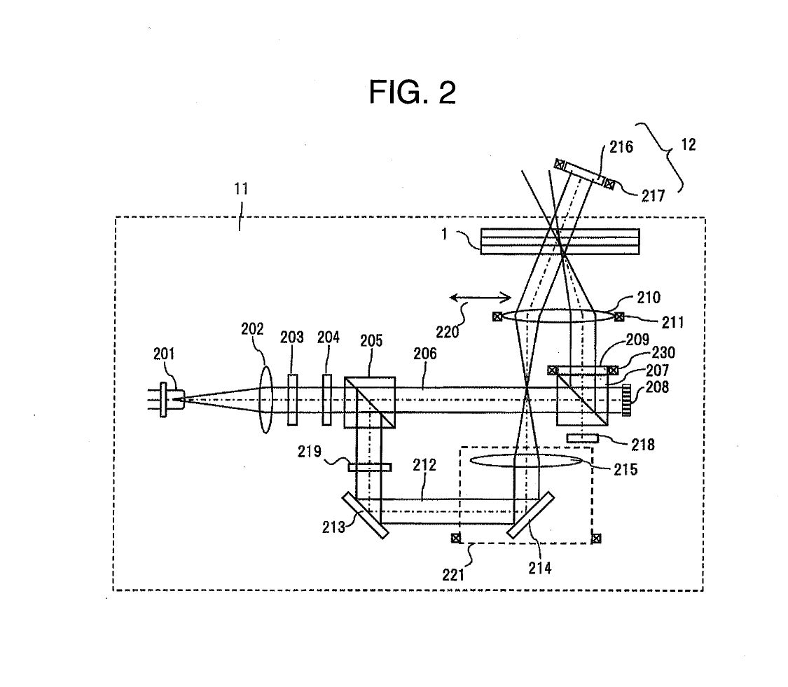

FIG. 2 is a diagram illustrating another configuration of an optical pickup 11. A light beam emitted from a light source 201 is transmitted through a collimating lens 202, and is incident on a shutter 203. When the shutter 203 is open, the light beam passes through the shutter 203, and is then incident on a polarization beam splitter 205, after a polarization direction is controlled such that light quantity ratios of p polarized light and s polarized light become desired ratios by an optical element 204 configured from a ½ wavelength plate and the like.

The light beam transmitted through the polarization beam splitter 205 is incident on a spatial light modulator 208 through a polarization beam splitter 207. Signal light 206 to which information is added by the spatial light modulator 208 is reflected at the polarization beam splitter 207, and is propagated in an angle filter 209 having a characteristic of allowing only a light beam with a predetermined incident angle to pass through. After that, the signal light beam is concentrated on an optical information recording medium 1 by an objective lens 210.

Meanwhile, the light beam reflected at the polarization beam splitter 205 works as reference light 212, is set to be in a predetermined polarization direction by a polarization direction conversion element 219 according to at the time of recording or at the time of reproduction, and is then incident on a lens 215 through a mirror 213 and a mirror 214. The lens 215 serves a function to concentrate the reference light 212 to a back focus surface of the objective lens 210, and the reference light once concentrated on the back focus surface of the objective lens 210 becomes parallel light again by the objective lens 210, and is incident on the optical information recording medium 1.

Here, the objective lens 210 or an optical block 221 can be driven in a direction illustrated by the reference sign 220, and the position of the objective lens 210 or the optical block 221 is shifted along a driving direction 220, so that a relative positional relationship between the objective lens 210 and a concentrated point on the back focus surface of the objective lens 210 is changed. Therefore, the incident angle of the reference light incident on the optical information recording medium 1 can be set to a desired angle. Note that the incident angle of the reference light may be set to the desired angle by driving the mirror 214 by an actuator, instead of driving the objective lens 210 or the optical block 221.

By causing the signal light and the reference light to be incident to be overlapped with each other in the optical information recording medium 1, an interference fringe pattern is formed in the optical information recording medium, and this pattern is written in the recording medium, so that information is recorded. Further, by shifting the position of the objective lens 210 or the optical block 221 along the driving direction 220, the incident angle of the reference light to be incident on the optical information recording medium 1 can be changed. Therefore, recording by angle multiplexing can be performed.

When the recorded information is reproduced, the reference light is incident on the optical information recording medium 1, and the light beam transmitted through the optical information recording medium 1 is reflected at a galvanometer mirror 216, so that reproduction reference light is generated, as described above. Reproduced light reproduced by the reproduction reference light is propagated in the objective lens 210 and the angle filter 209. After that, the reproduced light is transmitted through the polarization beam splitter 207 and is incident on a photodetector 218, and a recorded signal can be reproduced.

By configuring the optical system illustrated in FIG. 2 to cause the signal light and the reference light to be incident on the same objective lens, the optical system of FIG. 2 can have an advantage of a substantially decrease in size, compared with the optical system configuration illustrated in FIG. 1. The present invention can also be applied to the optical system like FIG. 2.

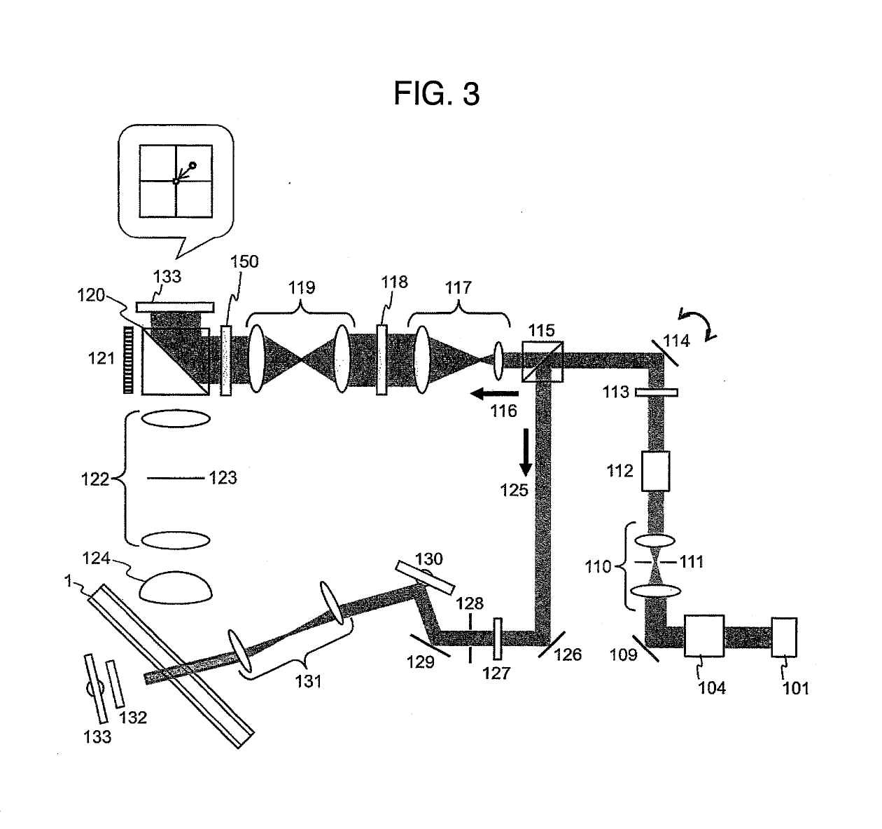

FIG. 3 illustrates a method of detecting angle deviation in the optical pickup 11 of FIG. 1. For example, when a laser is used as the light source 101, beam pointing cannot sometimes become constant on a constant basis, due to vibration, temperature, backlash of components, and the like. When the beam pointing is deviated, the incident angle of light to a target component becomes larger as a distance from the laser to the target component becomes larger, and an aberration occurs. Such an aberration may become a cause of deterioration of quality of a hologram reproduced image.

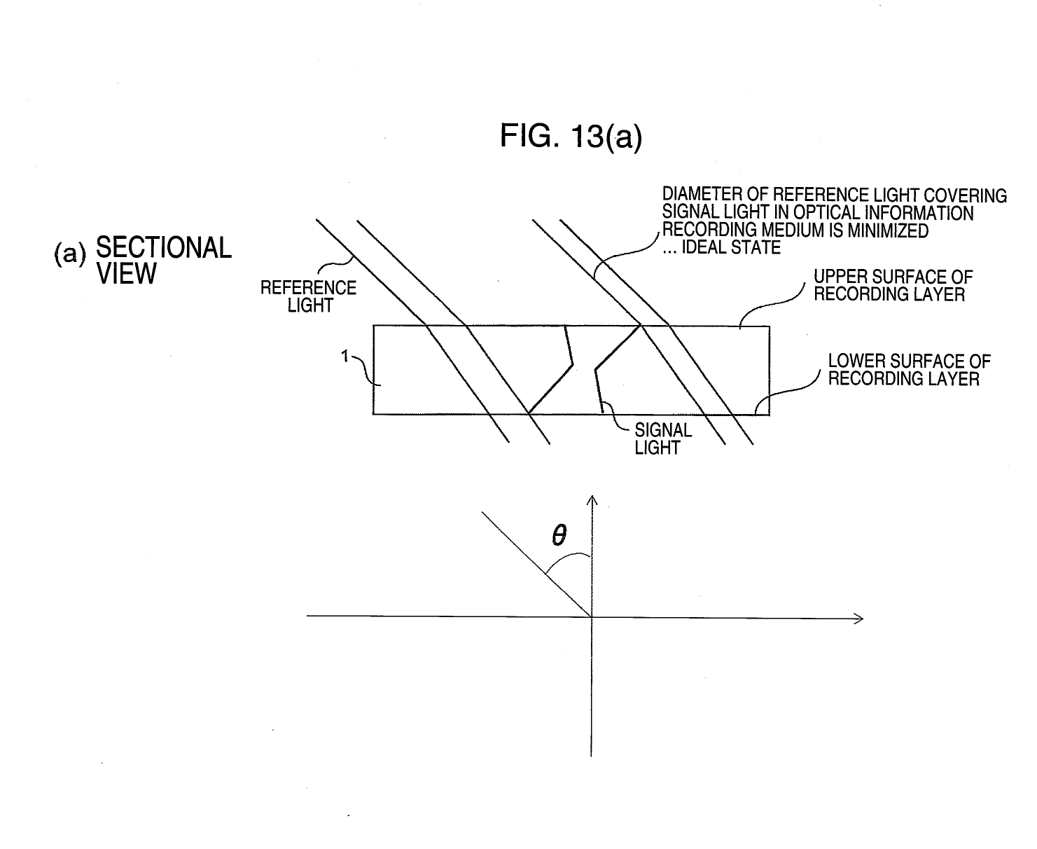

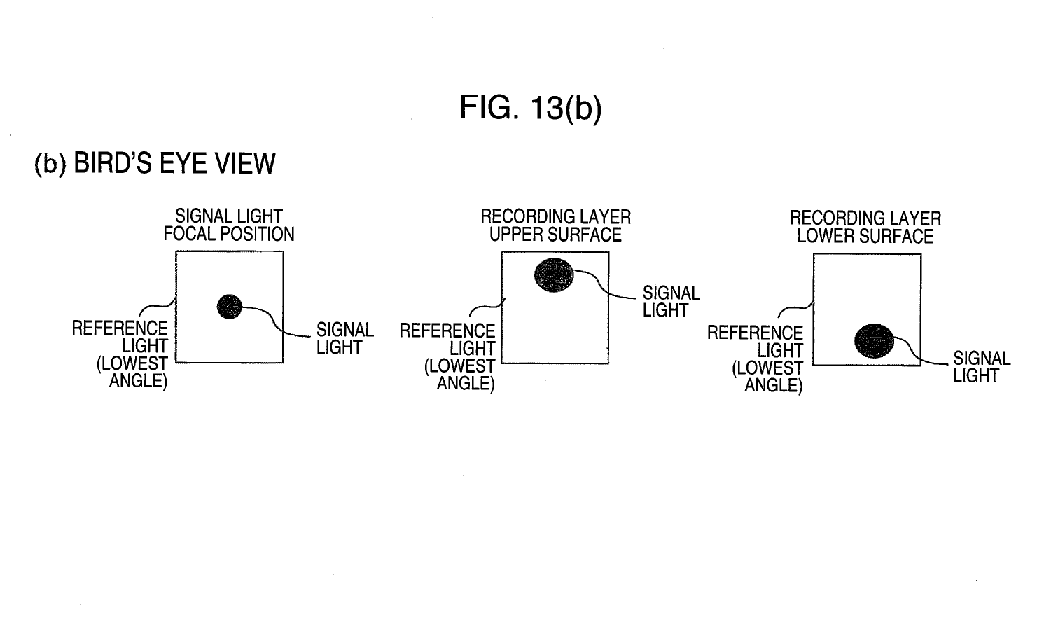

Therefore, in the present embodiment, detection of beam pointing deviation is performed in the photodetector 133 used at the time of reproduction of a hologram. As the photodetector 133, a camera may be used, for example. As illustrated in FIG. 13(a), it can be considered that the optical information recording medium can be most efficiently used for recording when an area (diameter) of the reference light that covers the signal light on the optical information recording medium is minimized Therefore, this state is defined as an ideal state. The ideal state has a profound effect in terms of prevention of unnecessary exposure of the optical information recording medium and high-density recording. However, in this case, if only a little position deviation or angle deviation of the optical component occurs, the signal light and the reference light stop interfering with each other, and reproduction quality is deteriorated. Therefore, the area of the reference light is desirably as small as possible although the area is not the minimum area. Further, as illustrated in FIG. 13(b), it is important to perform adjustment to cause the signal light to come to the center of the reference light in the vertical and horizontal directions in a focal position of the signal light, when the optical information recording medium is viewed from directly above, and to complete an optical system in which the reference light and the signal light interfere with each other on an upper surface and a lower surface of a recording layer of the optical information recording medium on a constant basis, at a lowest reference light angle used for recording in design (a smallest angle in design, which indicates an angle made by the reference light and a normal line of a boundary surface of the optical information recording medium, as illustrated in the lower drawing of FIG. 13(a)). After constant interference between the reference light and the signal light on the recording layer of the optical information recording medium is confirmed, the position of the photodetector 133 is adjusted so that the center of the beam of the signal light comes to the center of the photodetector 133. In this case, if an aperture as small as possible to the extent that the light can be temporarily detected after the relay lens 119 is inserted, and the light is focused to make the beam center of the signal light more recognizable, the adjustment can be easily performed. Further, as another method, a lens or the like may be inserted in front of the photodetector 133 to concentrate the signal light. Further, the position of the photodetector 133 may be adjusted to cause the beam center of the signal light to come to the center of the photodetector 133 when an area where the signal light and the reference light interfere is minimized.

Note that, here, the upper surface and the lower surface of the recording layer of the optical information recording medium indicate the portions illustrated in FIG. 13(a).

Note that it is necessary to cause the p polarized light transmitted through the PBS prism 115 to become the s polarized light in front of the PBS prism 120 in order to cause the p polarized light to be incident on the photodetector 133. Therefore, the ½ wavelength plate is inserted into an optical path from the PBS prism 115 to the PBS prism 120, to cause the p polarized light to the s polarized light. As another method, when a film of the PBS prism 115 is designed to transmit the p polarized light by 100% and reflect the s polarized light by 100%, if a film of the PBS prism 120 is designed to transit the p polarized light by 95% and reflect the p polarized light by 5%, and reflect the s polarized light by 100%, the light can be incident on the photodetector 133, and can be detected. The above methods are examples. The light is caused to be incident on the photodetector 133, and the beam pointing is detected, as described above. When the beam pointing deviation occurs, the position of the beam incident on a camera is changed. Therefore, the angle of the mirror 114 is adjusted so that the beam comes to the center of the photodetector 133, and the angle of the light is adjusted so that a maximum value of beam intensity comes to the center of the photodetector 133. Although described below, the optical element arranged between the light source 101 and the relay lens 110 in FIG. 3 performs angle adjustment to cause the aberration to be minimized Therefore, it is desirable to adjust the beam pointing, using the mirror 114 arranged in a subsequent stage of these elements. Note that this adjustment method is an example in the optical system of FIG. 3, and the method is not limited to the example. Further, in the present invention, the angle of the light is adjusted using the same photodetector as the photodetector used at the time of reproduction. Therefore, downsizing of the device can be achieved. Note that the present invention may use a photodetector different from the photodetector used at the time of reproduction.

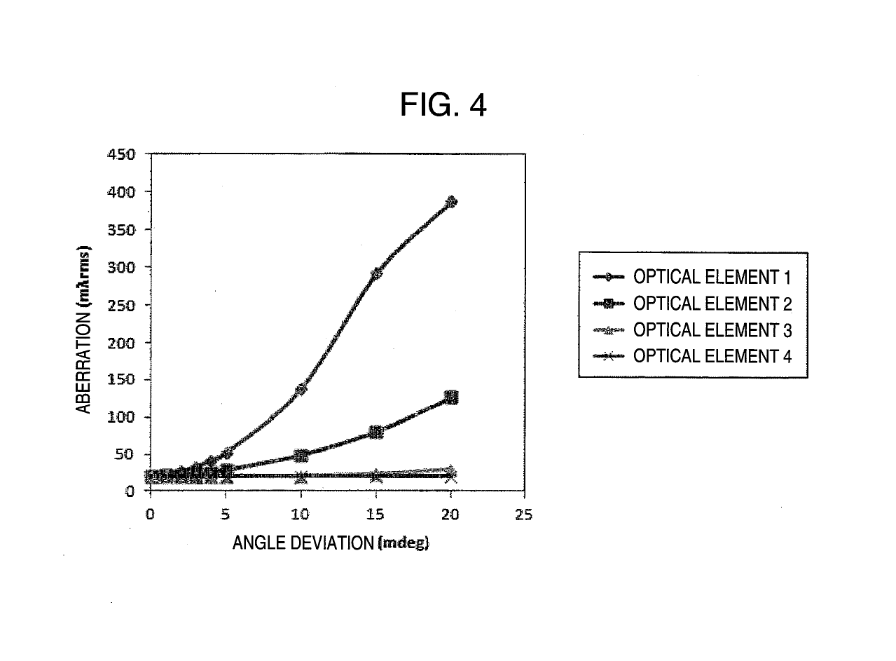

FIG. 4 is a graph illustrating sensitivity of the angle deviation with respect to the aberration, of principal optical components through which the reference light is transmitted in the optical pickup 11 of FIG. 1. The sensitivity to the aberration in the optical information recording medium becomes larger as the distance from the optical component to the optical information recording medium is longer. Meanwhile, to secure an SNR and obtain a high-quality reproduced image, it is necessary to suppress the aberration except a defocus aberration. When a specification value of the aberration is allocated to four optical components illustrated in FIG. 4, an angle deviation allowable value of the optical components becomes several mdeg, and highly accurate adjustment is required.

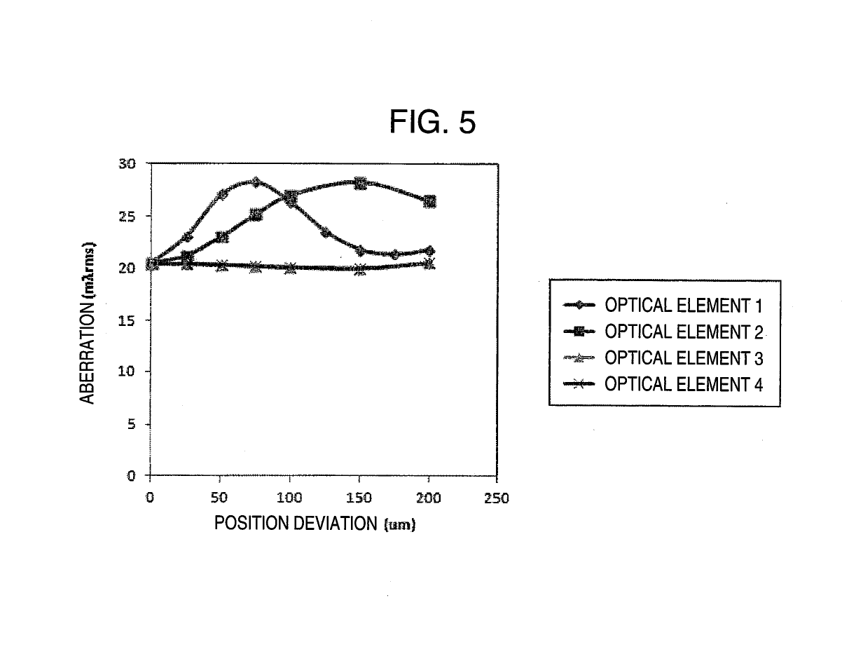

FIG. 5 is a graph illustrating sensitivity of the position deviation with respect to the aberration, of principal components through which the reference light is transmitted in the optical pickup 11 of FIG. 1. The optical components 1 to 4 respectively correspond to the components illustrated in FIG. 4. Similarly to the angle deviation, as a result of allocation of the aberration specification value to these four optical components, the position deviation allowable value becomes several mm. As is clear from the calculation results of FIGS. 4 and 5, to decrease the aberration and obtain a high-quality reproduced image, highly accurate angle adjustment of the optical components is required.

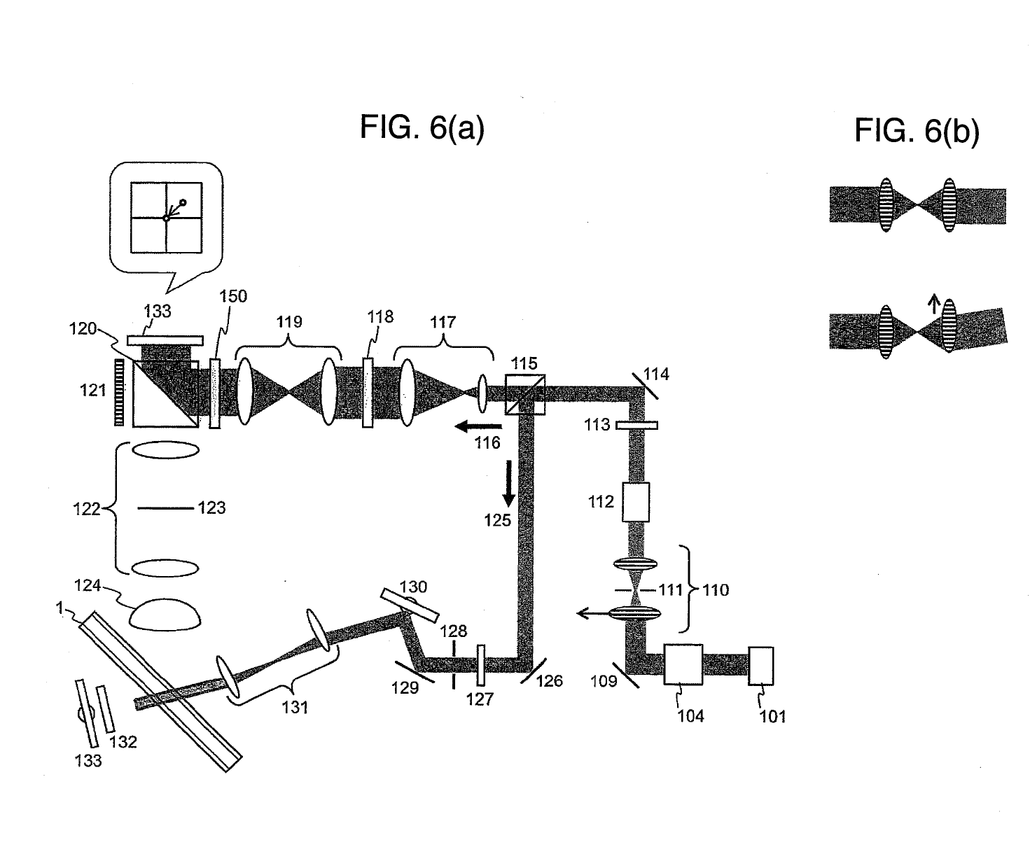

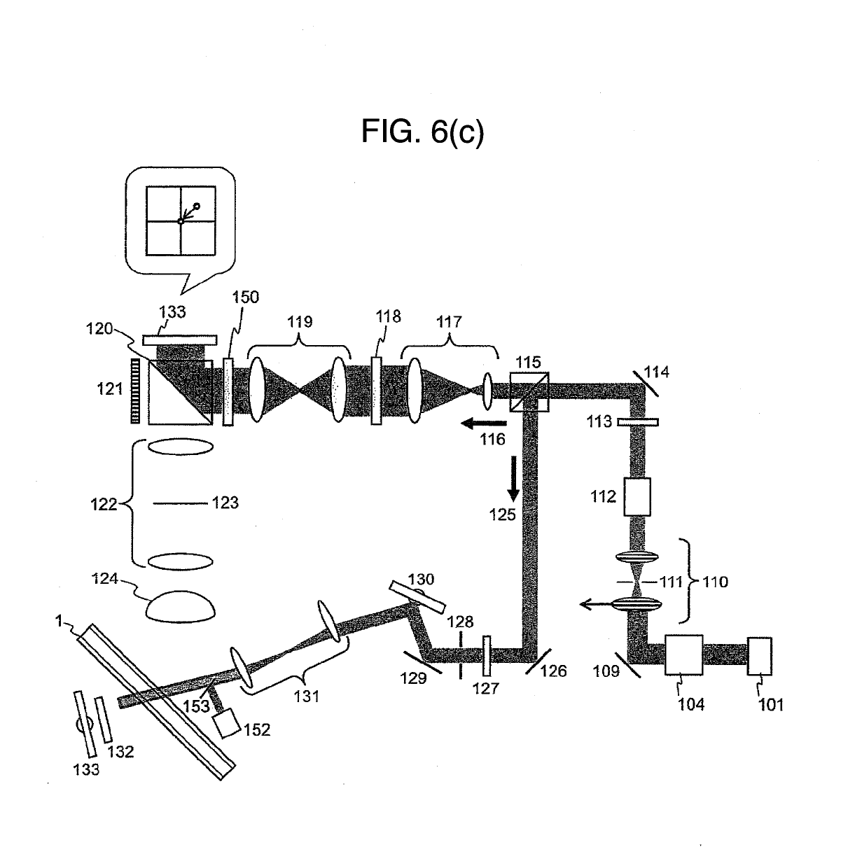

FIGS. 6(a) and 6(b) are diagrams illustrating the first embodiment for performing optical axis adjustment of the optical pickup 11 of FIG. 1. As illustrated in FIG. 6(a), a position adjustment mechanism is provided in the relay lens 110. The relay lens 110 in the present embodiment is a lens farthest from the optical information recording medium 1, and having the largest sensitivity of the aberration. The same two lenses are configured to put the focal point therebetween, as illustrated in FIG. 6(b). By adjusting one-side lens position, the angle of the emitted light can be changed.

The angle adjustment of the emitted light is performed such that transmitted light of the relay lens 110 is incident on a measuring device that can measures the aberration of the wavefront sensor or the like, and is adjusted in the position adjustment mechanism to cause the value of the aberration becomes small. As such adjustment by measuring the aberration of the light emitted from the optical component in the middle of the optical pickup 11, pre-shipment adjustment of a device can be considered. The position adjustment mechanism is driven by an element such as an actuator. Further, as illustrated in FIG. 6(c), the wavefront sensor 152 is arranged in front of the optical information recording medium, and the aberration there is detected at all times, and the actuator is driven in real time, so that not only the aberration at the time of initial assembly of the optical pickup 11, but also temporal change of the aberration is detected, whereby the aberration can be prevented and the high-quality hologram can be reproduced and recorded. When the temporal change of the aberration is detected, it is necessary to arrange a wavefront sensor in the device. While FIG. 6(c) illustrates an example of an optical system that causes a part of the emitted light of the scanner lens 131 to be reflected at the mirror, and to be incident on the wavefront sensor 152 has been described, the arrangement method and the arranged location of the wavefront sensor are not necessarily the same. Further, in reality, the mirror 153, which is arranged to cause the emitted light to be incident on the wavefront sensor, needs to be arranged in a location where the mirror 153 does not reject the light. Therefore, for example, it is necessary to employ a configuration in which the mirror reflects a part of the light only when the aberration is measured.

As described above, in the present embodiment, the optical axis adjustment is performed using the optical element having large aberration sensitivity, so that the aberration can be decreased, and the high-quality hologram image can be reproduced and recorded.

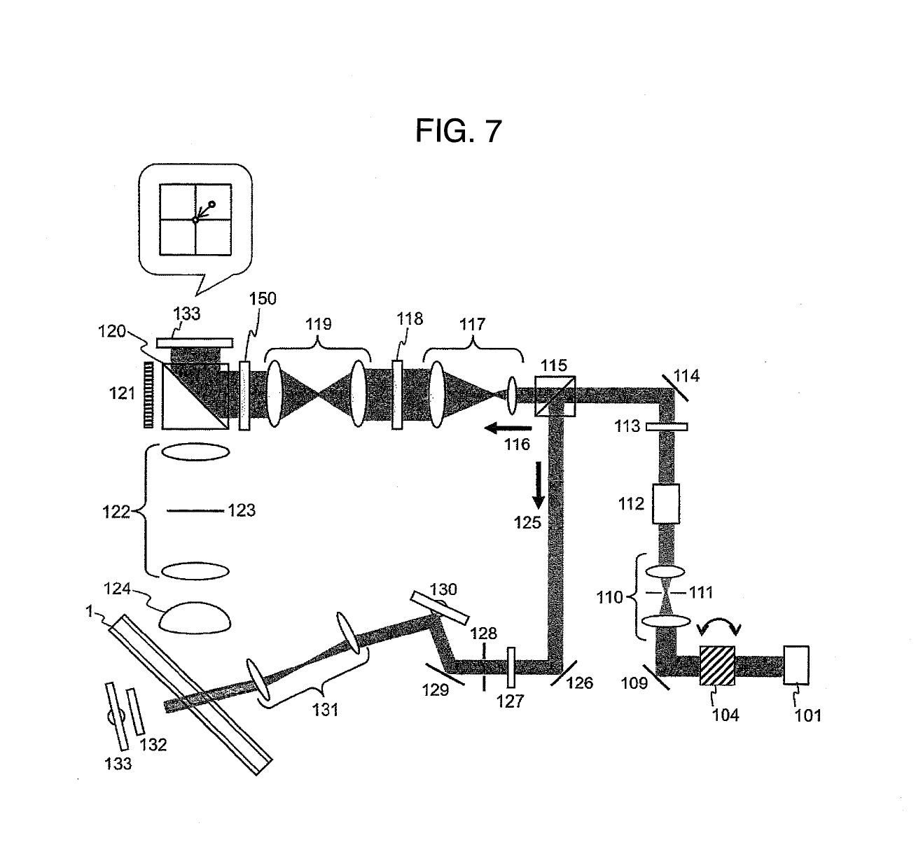

FIG. 7 is a diagram illustrating a second embodiment for performing optical axis adjustment of the optical pickup 11 of FIG. 1. An angle adjustment mechanism is provided in the beam shaping element 104 arranged in front of the relay lens 110 having the largest sensitivity of the aberration, so that the angle of the emitted light is adjusted. The angle adjustment mechanism of the beam shaping element 104 may also be driven by an actuator or the like, similarly to the embodiment of FIGS. 6(a) to 6(c). Accordingly, the aberration can be decreased, and the high-quality hologram image can be reproduced and recorded.

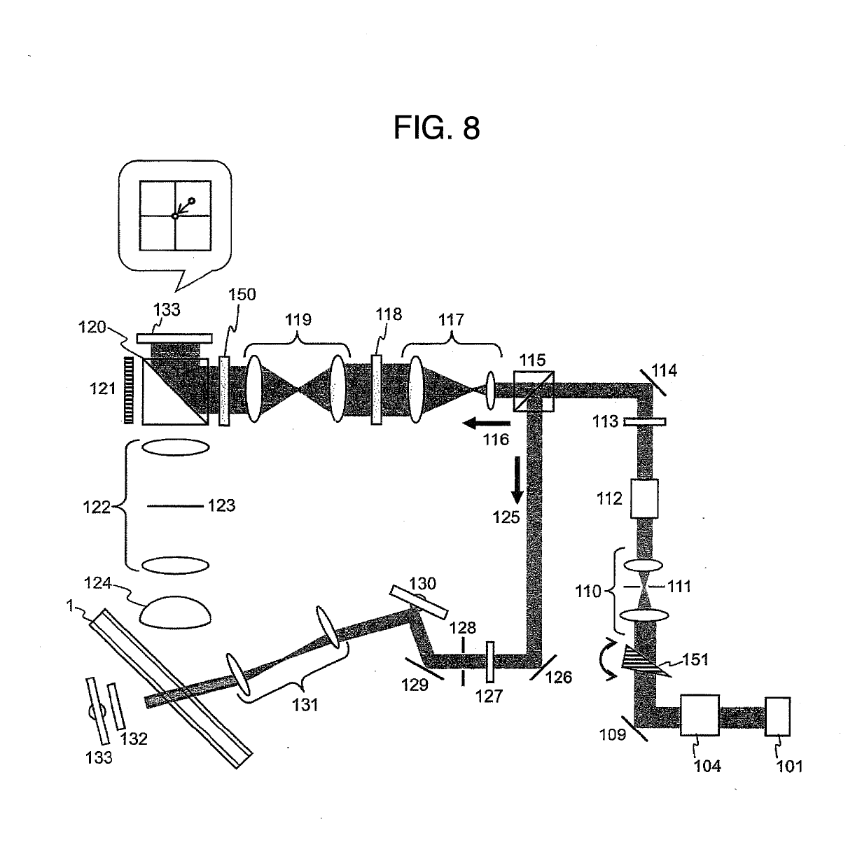

FIG. 8 is a diagram illustrating a third embodiment for performing optical axis adjustment of the optical pickup 11 of FIG. 1. An optical element 151 that changes the angle of the emitted light, like a wedge prism, is newly inserted in front of the relay lens 110 having the largest sensitivity of the aberration, and an angle adjustment mechanism is provided, so that the angle of the emitted light is adjusted. Similarly, this angle adjustment mechanism may also be driven by an actuator or the like. Accordingly, the aberration is decreased, and the high-quality hologram image can be reproduced and recorded.

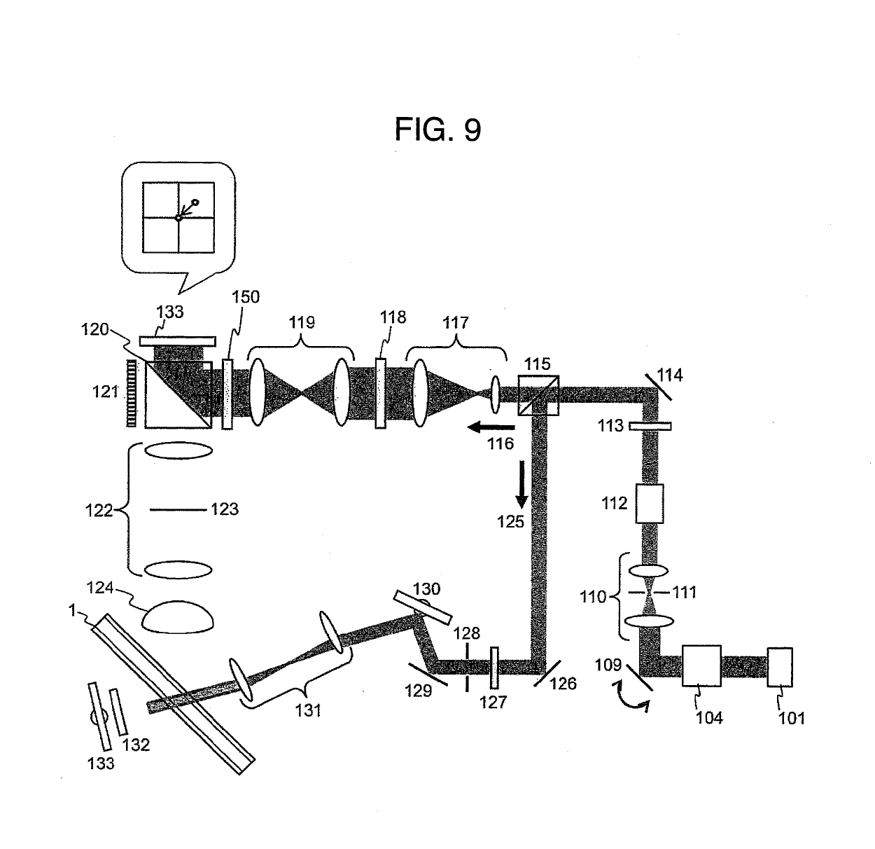

FIG. 9 is a diagram illustrating a fourth embodiment for performing optical axis adjustment of the optical pickup 11 of FIG. 1. As described above, when the sensitivity of the aberration of the relay lens 110 that is farthest from the optical information recording medium 1 is largest, an angle adjustment mechanism is provided in the mirror 109 arranged in front of the relay lens 110, so that the incident angle to the relay lens 110 is adjusted. Similarly, this angle adjustment mechanism may be driven by an actuator or the like.

Accordingly, the aberration can be decreased, and the high-quality hologram image can be reproduced and recorded. Further, according to the second to fourth embodiments, by performing the optical axis adjustment, using the optical element such as the beam shaping element, the wedge prism, or the mirror having smaller aberration sensitivity and arranged at a side closer to the light source 101 than the optical element such as the relay lens 110 having larger aberration sensitivity, fine adjustment can be performed, compared with a case where the optical element having large aberration sensitivity itself is driven.

All of the angle adjustment methods in the embodiments illustrated in FIGS. 6(a) to 6(c), to FIG. 9 cause the light transmitted through the optical component such as the relay lens 110 having large aberration sensitivity to be incident on the measuring device that can measure the wavefront aberration, such as the wavefront sensor, and adjusts the angle to cause the value of the aberration to become small. The optical component to which the angle adjustment mechanism is mounted is not limited to the present embodiment, and another component may be employed as long as the component can highly accurately control the incident angle with respect to the component having large aberration sensitivity. The present embodiments are examples. Further, all of the adjustment methods of FIGS. 6(a) to 6(c), to FIG. 9 are favorably provided with an aperture so that a correct arrival position of the light beam after the optical element 113 can be recognized. Highly accurate angle adjustment is performed within a range where the beam center passes through the aperture, and the aberration is minimized. While, typically, the laser light is emitted with light intensity distribution of Gaussian distribution, an optical component for converting the light intensity distribution to a Top-Hat shape may be introduced to the optical pickup 11 of the present invention. This optical component is a beam homogenizer or an apodizer, for example. When the light intensity distribution of the laser light is uniform, the high-quality hologram can be recorded when the information is added to the signal light in the spatial light modulator 121.

The element for converting the light intensity distribution into the Top-Hat shape is supposed to be manufactured with an aspherical-shaped lens. Typically, such an optical component having an aspherical shape is supposed to have large aberration sensitivity. Therefore, by providing the angle adjustment mechanism in this component itself, or in another component arranged in a preceding stage of the component, the high-quality hologram can be reproduced and recorded.

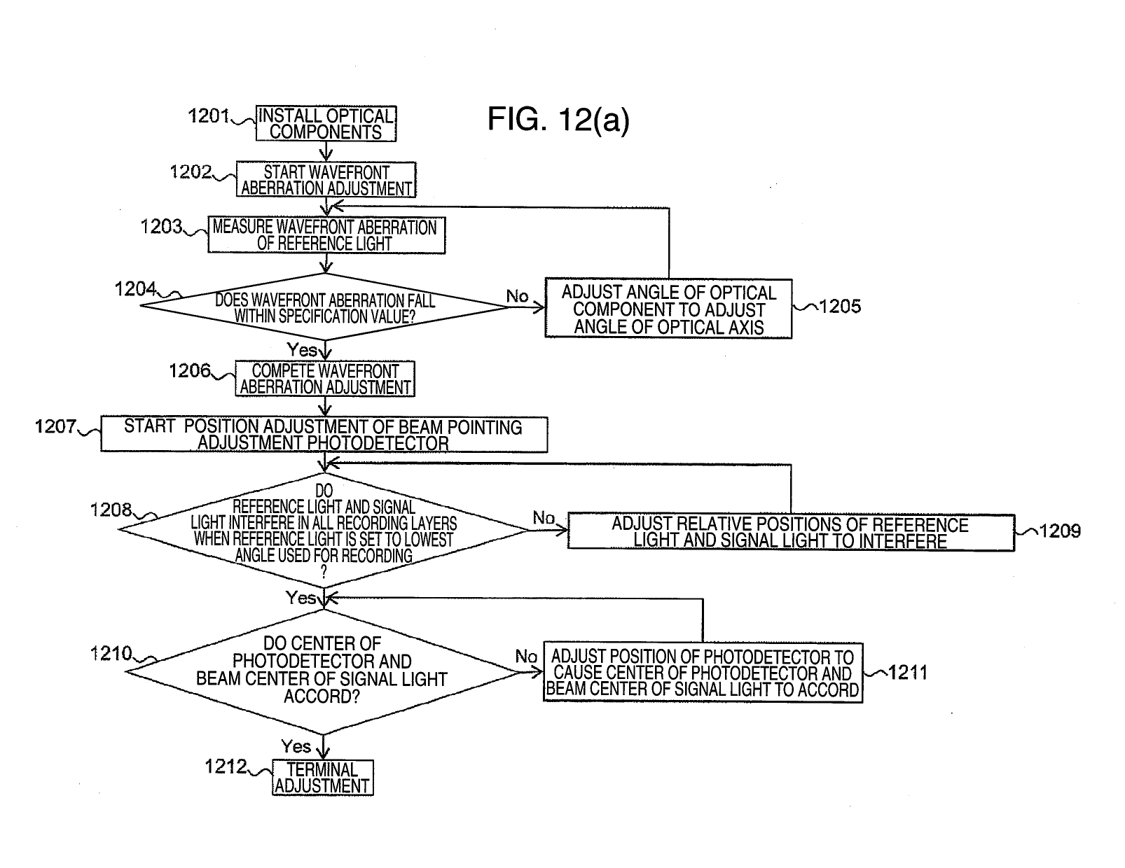

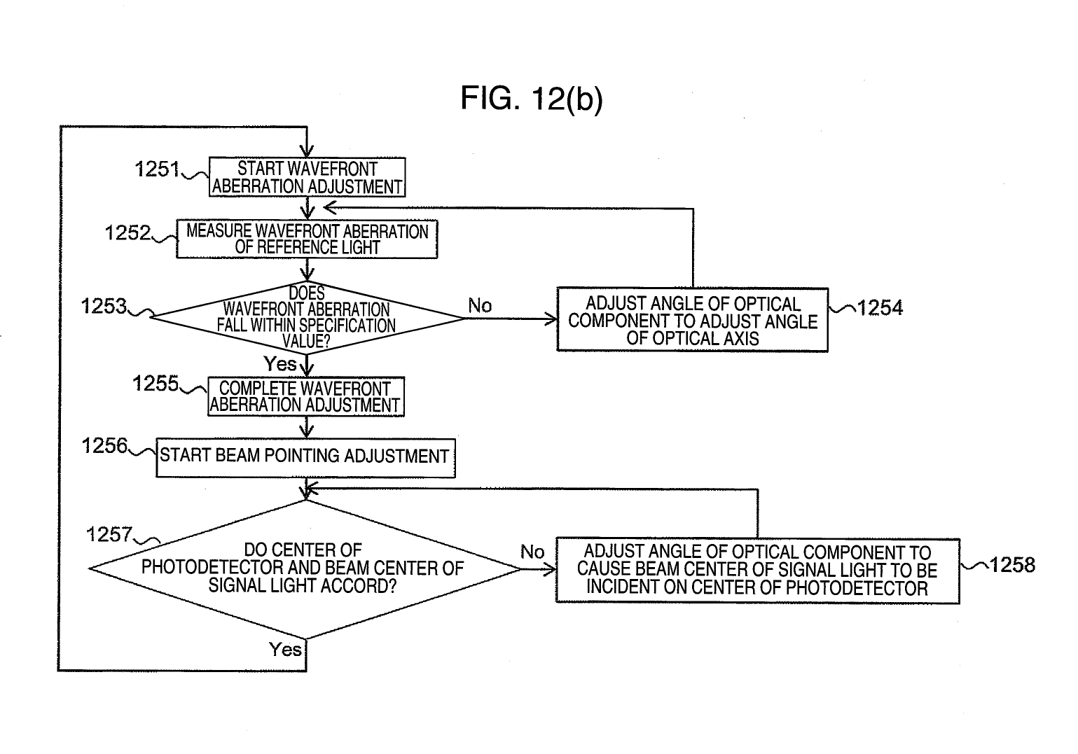

FIGS. 12(a) and 12(b) illustrate an example of an adjustment flow. FIG. 12(a) is a diagram for describing pre-shipment adjustment. The optical components are installed one by one in order from the light source for performing assembly of the optical pickup 11 (1201). From a perspective of the aberration, a decrease in the aberration of the reference light is mainly important. Therefore, the wavefront aberration of the reference light is measured (1202 and 1203) by the measuring device such as a wavefront sensor, and whether the aberration falls within the specification value is confirmed (1204). If the aberration does not fall within the specification value, the angle of the optical component described in FIGS. 6(a) to 6(c), to FIG. 9 is adjusted, and the angle of the optical axis is adjusted and the aberration is decreased (1205). If the aberration falls within the specification value, the adjustment of the aberration is completed (1206). Next, the position adjustment of the photodetector for beam pointing adjustment is started (1207). To be specific, the reference light and the signal light interfering with each other on all of an upper surface, an intermediate surface, and a lower surface of the recording layer of the optical information recording medium when the reference light is set to the lowers angle used in recording is confirmed (1208). When the interference does not occur, the relative position of the signal light and the reference light is adjusted to cause the interference (1209). When the adjustment has been made, the beam center of the signal light being incident on the center of the photodetector is confirmed (1210). When the signal light is incident on a position deviated from the center, an installed position of the photodetector is adjusted to cause the beam center to accord with the center of the photodetector (1211). The pre-shipment adjustment is terminated (1212). Next, adjustment during recording and reproduction processing illustrated in FIG. 12(b) will be described. When a wavefront aberration or deviation of the beam pointing occurs during recording or reproduction, it becomes difficult to obtain a reproduced image with a high SNR. Therefore, the present adjustment is favorably real time correction. First, the wavefront aberration of the reference light is measured (1251 and 1252). Whether the measured aberration falls within the specification value adjusted before shipment (1253), and if the measured aberration does not fall within the specification value, the angle of the optical axis is adjusted by the angle adjustment mechanism described in FIGS. 6(a) to 6(c), to FIG. 9 (1254), and the aberration is measured again. When the aberration falls within the specification value, the adjustment of the aberration is terminated (1255). Next, the beam pointing deviation is detected (1256). Whether the beam center of the signal light is incident on the center of the photodetector, which has been fixed in the pre-shipment adjustment is determined (1257), and if the beam center is not incident on the center of the photodetector, the angle of the optical component is adjusted, and the angle of the optical axis is caused to be incident on the center (1258). The above process is repeated every time page recording or page reproduction is terminated during recording or reproduction, so that the optical pickup 11 that can suppress the optical axis deviation and decrease the aberration, and can obtain the high-quality reproduced image can be provided. Further, the timing of the adjustment is not limited to the above described timing, and is changed according to an environment where the present recording/reproduction device is used, such as at the time of maintenance of the optical pickup, or at the timing of replacement of the light source.

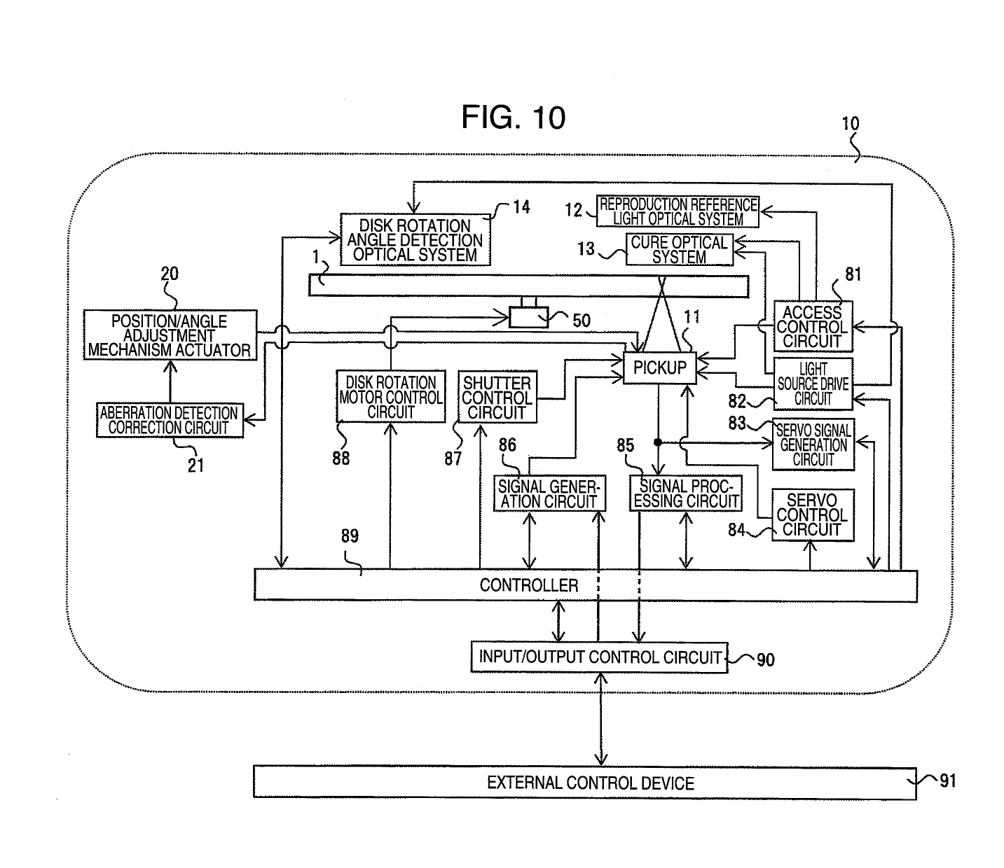

FIG. 10 is a block diagram illustrating a recording/reproduction device of an optical information recording medium that records/reproduces digital information, using holography. The optical information recording/reproduction device 10 is connected with an external control device 91 through an input/output control circuit 90. When recording is performed, the optical information recording/reproduction device 10 receives an information signal to be recorded from the external control device 91 with the input/output control circuit 90. When reproduction is performed, the optical information recording/reproduction device 10 transmits a reproduced information signal to the external control device 91 with the input/output control circuit 90. The optical information recording/reproduction device 10 includes the optical pickup 11, a reproduction reference light optical system 12, a cure optical system 13, a disk rotation angle detection optical system 14, and a rotation motor 50. The optical information recording medium 1 is configured to be rotatable with the rotation motor 50.

The optical pickup 11 serves a function to emit the reference light and the signal light to the optical information recording medium 1 and to record digital information in the recording medium, using holography. At this time, the information signal to be recorded is sent to a spatial light modulator in the optical pickup 11 through a signal generation circuit 86, by a controller 89, and the signal light is modulated by the spatial light modulator.

When the information recorded in the optical information recording medium 1 is reproduced, an optical wave that causes the reference light emitted from the optical pickup 11 to be incident on the optical information recording medium 1 in an opposite direction to the direction of at the time of recording is generated in the reproduction reference light optical system 12. The reproduced light reproduced with the reproduction reference light is detected by the photodetector described below in the optical pickup 11, and a signal is reproduced by a signal processing circuit 85.

The position/angle adjustment mechanisms of the present embodiment are associated with the optical component in the optical pickup 11. The aberration of the reference light is detected by an aberration detection correction circuit 21 from the optical pickup. Further, a signal for correcting the position and the angle of the optical component to minimize the value of the aberration is transmitted to a position/angle adjustment mechanism actuator 20, and the position/angle adjustment mechanisms of the optical component is driven.

An irradiation time of the reference light and the signal light irradiated with the optical information recording medium 1 can be adjusted by controlling an open/close time of the shutter in the optical pickup 11 with the controller 89 through a shutter control circuit 87.

The cure optical system 13 serves a function to generate the light beam to be used in pre-cure and post-cure of the optical information recording medium 1. The pre-cure is a pre-process of irradiating a desired position with a predetermined light beam in advance before irradiating the desired position with the reference light and the signal light, when information is recorded in the desired position in the optical information recording medium 1. The post-cure is a post-process of irradiating the desired position with a predetermined light beam to disable additional writing to the desired position, after the information is recorded in the desired position in the optical information recording medium 1.

The disk rotation angle detection optical system 14 is used to detect a rotation angle of the optical information recording medium 1. When the optical information recording medium 1 is adjusted to a predetermined rotation angle, a signal according to the rotation angle is detected by the disk rotation angle detection optical system 14, and the rotation angle of the optical information recording medium 1 can be controlled by the controller 89, using the detected signal, through a disk rotation motor control circuit 88.

A predetermined light source drive current is supplied from a light source drive circuit 82 to the optical pickup 11, the cure optical system 13, and the light source in the disk rotation angle detection optical system 14, and each light source can emit the light beam with a predetermined light quantity ratio.

Then, the optical pickup 11 and the disk cure optical system 13 are provided with a mechanism that can slide its position in a radius direction of the optical information recording medium 1, and position control is performed through an access control circuit 81.

By the way, the recording technologies using a principle of the angle multiplexing of holography tend to have an extreme small allowable error to the deviation of the reference light angle.

Therefore, it is necessary to provide a mechanism to detect a deviation amount of the reference light angle in the optical pickup 11 and generate a servo control signal in a servo signal generation circuit 83, and to provide a servo mechanism to correct the deviation amount through a servo control circuit 84 in the optical information recording/reproduction device 10.

Further, some of or all of the optical system configurations of the optical pickup 11, the cure optical system 13, and the disk rotation angle detection optical system 14 may be integrated and simplified.

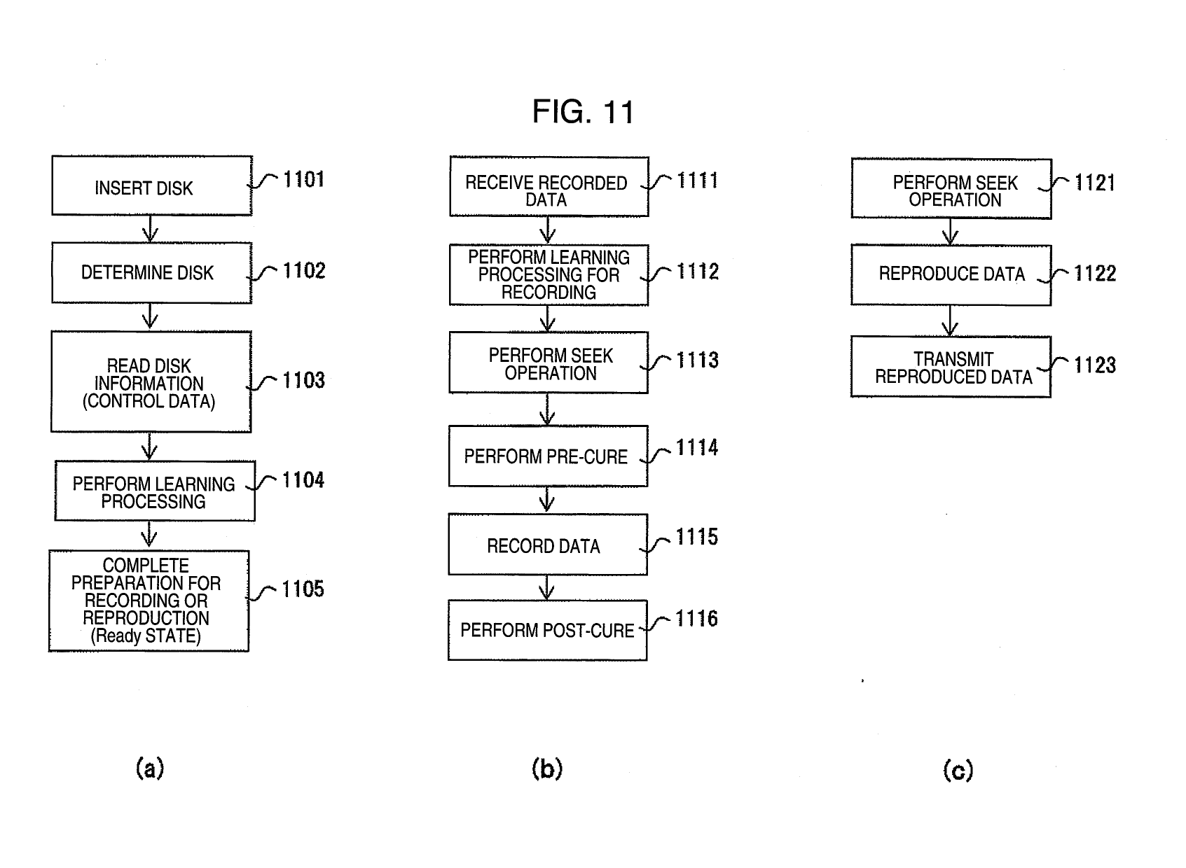

FIGS. 11(a) to 11(c) illustrate operation flows of recording and reproduction in the optical information recording/reproduction device 10. Here, flows related to recording and reproduction using holography will be especially described.

FIG. 11(a) illustrates an operation flow from after the optical information recording medium 1 is inserted into the optical information recording/reproduction device 10, to when preparation of recording or reproduction is completed, FIG. 11(b) illustrates an operation flow from the preparation completion state to when information is recorded in the optical information recording medium 1, and FIG. 11(c) illustrates an operation flow from the preparation completion state to when the information recorded in the optical information recording medium 1 is reproduced.

When the medium is inserted, as illustrated in FIG. 11(a) (1101), the optical information recording/reproduction device 10 determines whether the inserted medium is an optical information recording medium that records or reproduces digital information, using holography (1102).

As a result of the determination of the optical information recording medium, when the inserted medium is determined to be the optical information recording medium that records or reproduces digital information, using holography, the optical information recording/reproduction device 10 reads control data provided in the optical information recording medium (1103), and acquires, for example, information related to the optical information recording medium and information related to various setting conditions at the time of recording and reproduction.

After the read of the control data, the optical information recording/reproduction device 10 performs various types of adjustment according to the control data and learning processing related to the pickup 11 (1104), and completes preparation of recording or reproduction (1105).

The operation flow from the preparation completion state to when information is recorded is to first receive data to be recorded (1111), and send information according to the data to the spatial light modulator in the optical pickup 11, as illustrated in FIG. 11(b).

Following that, various types of learning processing for recording such as power optimization of the light source 301, and optimization of an exposure time by the shutter 303 are performed as needed, in advance (1112) so that the high-quality information can be recorded in the optical information recording medium.

Following that, in a seek operation (1113), the access control circuit 81 is controlled, and the optical pickup 11 and the cure optical system 13 are positioned to predetermined positions of the optical information recording medium 1. When the optical information recording medium 1 has address information, the address information is reproduced, and whether the optical pickup 11 and the cure optical system 13 are positioned to target positions is confirmed. If the optical pickup 11 and the cure optical system 13 are not positioned to the target positions, deviation amounts from the predetermined positions are calculated, and the positioning operation is repeated again.

Following that, a predetermined region is procured using the light beam emitted from the cure optical system 13 (1114), and data is recorded using the reference light and the signal light emitted from the pickup 11 (1115).

After the data is recorded, the post-cure is performed using the light beam emitted from the cure optical system 13 (1116). The data may be verified as needed.

The operation flow from the preparation completion state to when recorded information is reproduced is to control the access control circuit 81 in the seek operation (1121), and to position the optical pickup 11 and the reproduction reference light optical system 12 to predetermined positions of the optical information recording medium 1, as illustrated in FIG. 11(c). When the optical information recording medium 1 has address information, the address information is reproduced, and whether the optical pickup 11 and the reproduction reference light optical system 12 are positioned to target positions is confirmed. If the optical pickup 11 and the reproduction reference light optical system 12 are not arranged to the target positions, deviation amount from the predetermined positions are calculated, and the positioning operation is repeated again.

Following that, the reference light is emitted from the optical pickup 11, the information recorded in the optical information recording medium 1 is read (1122), and reproduced data is transmitted (1123).

According to the embodiments, the position deviation and the angle deviation of the optical component arranged in the optical information recording/reproduction device can be adjusted, and as a result, the high-quality hologram can be recorded and reproduced. Further, when attachment/detachment of the laser light source becomes necessary at the end of life or at the time of failure, adjustment of the optical axis of the optical system is required. By providing the position/angle adjustment mechanism to the principal optical components, a work time can be reduced. Further, the optical axis of the optical system is adjusted during waiting for stabilization of oscillation of the laser light source, so that the time to start recording can be reduced, and efficiency of workability can be improved.

The present invention is not limited to the above-described embodiments, and includes various modifications. For example, the above embodiments have been described in detail to explain the present invention in a simplified manner, and the present invention is not necessarily limited to one provided with all described configurations. Further, a part of the configuration of a certain embodiment can be replaced with the configuration of another embodiment. Further, the configuration of another embodiment can be added to the configuration of a certain embodiment. Further, another configuration can be added to/deleted from/replaced with a part of the configuration of each embodiment.

Further, the above-described configurations, functions, processing units, processing means, and the like may be realized by hardware, by designing a part or the whole of the configurations, functions, processing units, and processing means with an integrated circuit, for example. Further, the above-described configurations, functions, and the like may be realized by software, by a processor interpreting and executing a program that realizes the respective functions. Information such as programs, tables, and files that realize the respective functions can be placed in a recording device such as a memory, a hard disk, or a solid state drive (SSD), or a recording medium such as an IC card, an SD card or a DVD.

Further, control lines and information lines that are necessary for description have been described, and not all of control lines and information lines necessary for a product are necessarily described. In practice, it may be considered that almost all of the configurations are mutually connected.

### REFERENCE SIGNS LIST

1 . . . Optical information recording medium, 10 . . . Optical information recording/reproduction device, 11 . . . Optical pickup, 12 . . . Reproduction reference light optical system, 13 . . . Cure optical system, 14 . . . Disk rotation angle detection optical system, 20 . . . Position/angle adjustment mechanism actuator, 21 . . . Aberration detection correction circuit, 50 . . . Rotation motor, 81 . . . Access control circuit, 82 . . . Light source drive circuit, 83 . . . Servo signal generation circuit, 84 . . . Servo control circuit, 85 . . . Signal processing circuit, 86 . . . Signal generation circuit, 87 . . . Shutter control circuit, 88 . . . Disk rotation motor control circuit, 89 . . . Controller, 90 . . . Input/output control circuit, 91 . . . External control device, 101 . . . Light source, 104 . . . Beam shaping element, 109 . . . Mirror, 110 . . . Relay lens, 111 . . . Shutter, 112 . . . Optical isolator, 113 . . . ½ wavelength plate, 114 . . . Mirror, 115 . . . PBS prism, 116 . . . Signal light, 117 . . . Beam expander, 118 . . . Phase mask, 119 . . . Relay lens, 120 . . . PBS prism, 121 . . . Spatial light modulator, 122 . . . Relay lens, 123 . . . Polytopic filter, 124 . . . Objective lens, 125 . . . Reference light, 126 . . . Mirror, 127 . . . Angle adjustment element in pitch direction, 128 . . . Aperture, 129 . . . Mirror, 130 . . . Galvanometer mirror, 131 . . . Scanner lens, 132 . . . ¼ wavelength plate, 133 . . . Galvanometer mirror, 201 . . . Light source, 202 . . . Collimating lens, 203 . . . Shutter, 204 . . . ½ wavelength plate, 205 . . . Polarization beam splitter, 206 . . . Signal light, 207 . . . Polarization beam splitter, 208 . . . Spatial light modulator, 209 . . . Angle filter, 210 . . . Objective lens, 211 . . . Objective lens actuator, 212 . . . Reference light, 213 . . . Mirror, 214 . . . Mirror, 215 . . . Lens, 216 . . . Mirror, 217 . . . Actuator, 218 . . . Photodetector, 219 . . . Polarization direction conversion element, 220 . . . Driving direction, 221 . . . Optical block, 230 . . . Actuator, 150 . . . ½ wavelength plate, 151 . . . Angle change element, 152 . . . Wavefront sensor, 153 . . . Mirror

1: An optical information recording/reproduction device that irradiates an optical information recording medium with signal light and reference light to form a hologram to record information, and irradiates the hologram of the optical information recording medium with the reference light to reproduce information, the optical information recording/reproduction device comprising:
a laser light source configured to emit laser light;
a branching element configured to branch the laser light from the laser light source to the signal light and the reference light;
a spatial light modulation unit for adding two-dimensional information to the signal light;
an objective lens for irradiating the optical information recording medium with the signal light;
a photodetector configured to detect diffracted light from the optical information recording medium when the optical information recording medium is irradiated with the reference light;
an optical axis adjustment unit arranged between the laser light source and the branching element, and configured to adjust an optical axis of the laser light

2: The optical information recording/reproduction device according to claim 1, wherein
the optical axis adjustment unit adjusts angles of the signal light and the reference light incident on the optical information recording medium to cause the signal light and the reference light to interfere with each other on the optical information recording medium.

3: The optical information recording/reproduction device according to claim 1, further comprising:
a wavefront measurement unit configured to measure a wavefront aberration of the laser light, wherein
the optical axis adjustment unit adjusts the optical axis of the laser light to cause the measured wavefront aberration to become small.

4: The optical information recording/reproduction device according to claim 1, wherein
the photodetector detects at least a part of the signal light, and
the optical axis adjustment unit adjusts the optical axis of the laser light, based on the detected result.

5: The optical information recording/reproduction device according to claim 4, wherein
the optical axis adjustment unit adjusts the optical axis of the laser light to cause the signal light to be incident on a center of the photodetector.

6: The optical information recording/reproduction device according to claim 1, wherein
a first optical element having first aberration sensitivity and a second optical element having second aberration sensitivity smaller than the first aberration sensitivity are arranged between the laser light source and the branching element,
the second optical element is arranged at a side closer to the laser light source than the first optical element, and
the optical axis adjustment unit drives the first optical element to adjust the optical axis of the laser light.

7. (canceled)

8: The optical information recording/reproduction device according to claim 1, wherein
a relay lens is arranged between the laser light source and the branching element.

9: The optical information recording/reproduction device according to claim 8, wherein
the optical axis adjustment unit drives the relay lens to adjust the optical axis of the laser light.

10: The optical information recording/reproduction device according to claim 8, wherein
a beam shaping element is arranged at a side close to the laser light source than the relay lens, and
the optical axis adjustment unit drives the beam shaping element to adjust the optical axis of the laser light.

11: The optical information recording/reproduction device according to claim 8, wherein
a wedge prism is arranged at a side closer to the laser light source than the relay lens, and
the optical axis adjustment unit drives the wedge prism to adjust the optical axis of the laser light.

12: The optical information recording/reproduction device according to claim 8, wherein
a mirror that reflects the laser light is arranged at a side close to the laser light source than the relay lens, and
the optical axis adjustment unit drives the mirror to adjust the optical axis of the laser light.

13: An adjustment method of an optical axis in an optical information recording/reproduction device that irradiates an optical information recording medium with signal light and reference light to form a hologram to record information, and irradiates the hologram of the optical information recording medium with the reference light to reproduce information, the method comprising the steps of:
emitting a laser light by a laser light source;
branching the laser light to a signal light and a reference light by a branching element; and
adjusting an optical axis of the laser light by an optical axis adjustment unit arranged between the laser light source and the branching element.

14: The adjustment method according to claim 13, further comprising the step of:
measuring a wavefront aberration of the laser light, wherein
the adjusting step adjusts the optical axis of the laser light to cause the measured wavefront aberration to become small.

15: The adjustment method according to claim 13, further comprising the step of:
detecting at least a part of the signal light, wherein
the adjusting step adjusts the optical axis of the laser light, based on the detected result.

16: An adjustment method of an optical axis in an optical information recording/reproduction device that irradiates an optical information recording medium with signal light and reference light to form a hologram to record information, and irradiates the hologram of the optical information recording medium with the reference light to reproduce information, the method comprising the steps of:
emitting laser light by a laser light source;
branching the laser light to signal light and reference light by a branching element;
detecting at least a part of the signal light by a photodetector; and
adjusting arrangement of the photodetector to cause the signal light to be incident on a center of the photodetector, when the reference light interferes with the signal light at an upper surface and a lower surface of a recording layer of the optical information recording medium at a lowest reference light angle that is used for recording.
